(19) United States
(12) Patent Application Publication
(10) Pub. No.: US 2015/0140261 A1
(43) Pub. Date: May 21, 2015

(54) Vehicle floor mat

(71) Applicant: Michael Papp, Tecumseh (CA)

(72) Inventor: Michael Papp, Tecumseh (CA)

(21) Appl. No.: 13/998,633

(22) Filed: Nov. 19, 2013

(51) Int. Cl. B60N 3/04; B29D 99/00; B29C 45/14

(52) U.S. Cl. CPC B60N 3/046; B29C 45/14311; B29D 99/0057; B29K 2101/12
USPC 428/100; 264/154

(57) ABSTRACT

A vehicle floor mat includes a sheet of flexible thermoplastic elastomer containing at least one rigid plastic insert. The insert includes Velcro® hooks extending downwardly from its bottom surface for connecting the mat to a vehicle carpet or Velcro® loops on a pad connected to the vehicle floor pan. The insert is molded in a first injection molding operation, and then the sheet is molded around the top, sides and ends of the insert.

### BACKGROUND OF THE INVENTION

1. Field of the Invention

This invention relates to a floor mat for a motor vehicle.

2. Description of the Related Art

Vehicle floor mats are typically used on the carpets in front of the driver's seat, and all front and rear passenger seats. It is not unusual for such mats to slide to another location in a vehicle. This can be a problem when a mat rides up beneath a gas pedal and interferes with the operation of the pedal.

### BRIEF SUMMARY OF THE INVENTION

Accordingly, the present invention relates to a flexible molded thermoplastic mat with a rigid plastic section or sections carrying Velcro® hooks on the outer surface thereof for gripping a vehicle carpet to retain the mat in a fixed position. Suitable flexible thermoplastic materials include thermoplastic elastomers (TPE) such as thermoplastic vinyl (TPV) and a Kraton® polymer SEBS (styrene ethylene butylene styrene). Suitable rigid plastics include polypropylene, acrylonitrile butadiene styrene (ABS) and polycarbonate/ABS (PC/ABS).

The mat is produced using a two shot injection molding apparatus. The rigid plastic carrying the Velcro® hooks is molded in a first injection, and then a moldable thermoplastic elastomer (TPE) is injected around and over the rigid plastic to allow the soft TPE to mechanically and/or chemically bond to the rigid plastic. Mechanical bonding can be achieved by forming openings in the rigid plastic through which the soft elastomer flows during the second injection molding step.

### BRIEF DESCRIPTION OF THE DRAWINGS

The invention is described below with reference to the accompanying drawings, which illustrate preferred embodiments of the invention, and wherein:

FIG. 1 is a schematic top view of a vehicle floor mat in accordance with the invention;

FIG. 2 is a cross section taken generally along line 2-2 of FIG. 1;

FIG. 3 is a cross section similar to FIG. 2 of a second embodiment of the invention; and

FIG. 4 is a cross section similar to FIG. 2 of a third embodiment of the invention.

It will be appreciated that the drawings are not to scale.

### DETAILED DESCRIPTION OF THE INVENTION

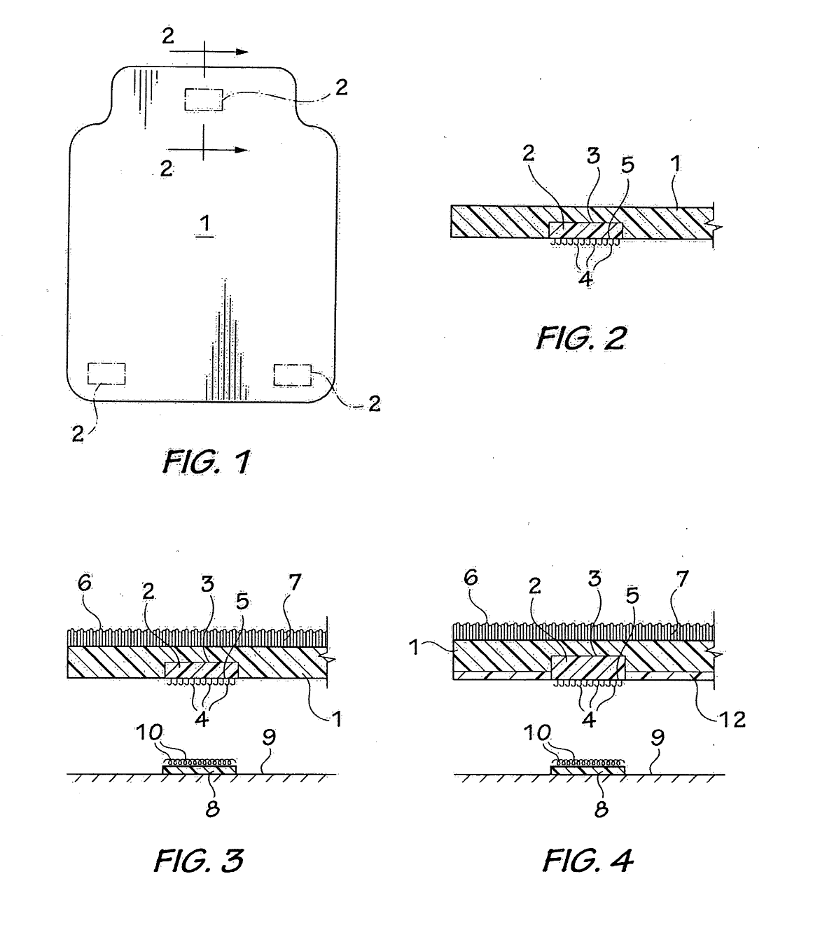

Referring to FIG. 1, the floor mat of the present invention includes a sheet 1 formed of a flexible thermoplastic material. As mentioned above, suitable materials include thermoplastic elastomers such as thermoplastic vinyl and Kraton® polymer SEBS (styrene ethylene butylene styrene). Rigid plastic inserts 2 are provided in recesses 3 (FIG. 2) at various locations of the sheet 1. It is possible to provide one large insert 2 in the sheet 1, e.g. in the center of the sheet. The number and locations of the inserts 2 is not critical. It is merely necessary to provide one or more inserts which prevent movement of the mat relative to the carpet on the floor of a vehicle.

The inserts 2 are formed of a rigid plastic such polypropylene, acrylonitrile butadiene styrene (ABS) or polycarbonate/ABS (PC/ABS). Hooks 4 of a hook and loop fastener (Velcro®) are integral with and extend downwardly from the bottom surface 5 of each insert 2. The mat is produced by first injection molding the hard plastic inserts 2. The inserts 2 are placed in a mold, the mold is closed and the sheet 1 of thermoplastic material is molding over the top and around the sides and ends of the inserts. During the second molding operation, the inserts 2 are chemically bonded to the sheet 1. Mechanical bolding can be achieved by forming holes in the rigid plastic inserts 2. During the second molding step, the soft elastomer flows through the holes. The resulting mat can be placed on the carpet (not shown in FIG. 2) of a vehicle and the inserts 2 attach to the carpet fabric to prevent movement of the mat relative to the carpet.

As shown in FIG. 3, in a second embodiment of the invention, the thermoplastic sheet 1 can form the backing layer of a fabric carpet 6, i.e., the top layer 7 of the carpet can be glued or otherwise connected to the thermoplastic sheet 1, which is then connected to a pad 8 attached to a vehicle floor pan 9. Loops 10 extend upwardly from the pad 8 for engagement by the hooks 4.

With reference to FIG. 4, a third embodiment of the invention includes the same elements of the mat of FIGS. 1 and 2, except that the sheet 1 is sandwiched between the top fabric layer 7 and a bottom layer or sheet 11 of a conventional vehicle carpet or floor mat. The inserts 2 or at least the hooks 4 extend downwardly beneath the carpet bottom layer 12 for engaging either the fixed carpet in a vehicle or the loops 10 on a pad 8 glued or otherwise secured to the metal floor pan 9 of a vehicle.

1. A motor vehicle floor mat comprising a flexible thermoplastic sheet; at least one rigid plastic insert mounted in the sheet; and hooks on a bottom surface of said at least one plastic insert extending downwardly beyond a bottom surface of the sheet for connecting the mat to a vehicle carpet or loops extending upwardly from the vehicle floor.

2. The floor mat of claim 1, wherein the sheet is formed of a thermoplastic elastomer.

3. The floor mat of claim 1, wherein the thermoplastic elastomer is selected from the group consisting of thermoplastic vinyl and styrene ethylene butylene styrene.

4. The floor mat of claim 2, wherein the flexible sheet is formed of a material selected from the group consisting of polypropylene, acrylonitrile butadiene styrene and polycarbonate/acrylonitrile butadiene styrene.

5. The floor mat of claim 1, including a recess in the bottom surface of the sheet for receiving said at least one insert.

6. The floor mat of claim 1, wherein the top surface of the sheet is connected to the bottom surface of a fabric carpet to form a bottom layer of the carpet.

7. The floor mat of claim 1, wherein the sheet is sandwiched between the top and bottom layers of a fabric carpet with the hooks extending beneath said carpet bottom layer for connecting the carpet to another carpet or to loops extending upwardly from a pad on a vehicle floor pan.

8. A method of producing a vehicle floor mat including the steps of molding at least one rigid plastic insert with hooks extending downwardly from a bottom surface thereof; placing said at least one insert in a mold; and molding a flexible sheet around a top surface, sides and ends of the insert, whereby the hooks extend downwardly beyond a bottom surface of the sheet for connecting the mat to a fabric carpet or loops extending upwardly from a vehicle floor pan.

9. The method of claim 7, including the step of forming holes in the insert before molding the sheet to achieve a mechanical bond between the sheet and the insert when sheet material flows through the holes during molding of the sheet.
